(19) United States
(12) Patent Application Publication
(10) Pub. No.: US 2009/0314143 A1
(43) Pub. Date: Dec. 24, 2009

(54) SCREW BAND LOCKING DEVICE

(76) Inventor: HO-TIEN CHEN, Tainan City (TW)

Correspondence Address: J.C. Patents, Suite 250, 4 Venture, Irvine, CA, 92618, US

(21) Appl. No.: 12/144,554

(22) Filed: Jun. 23, 2008

(51) Int. Cl. B25B 23/155; B25B 23/04

(52) U.S. Cl. 81/472; 81/433

(57) ABSTRACT

A screw band locking device includes a linking sleeve, a torque releasing device, a quick connecting head, and a band transmitting device. The linking sleeve is combined with a powered hand tool. The torque releasing device has a combining rod with one end to be combined with a powered hand tool and the other end for an outer ring to fit around. A locking-depth adjusting ring is combined with the outer ring, and the combining rod has a combining groove for receiving a screw driver. A driving member is located at an outer side of the torque releasing device. The band transmitting device has a main body to be combined fixedly with the linking sleeve, with the torque releasing device installed in an inner rear portion of the main body. Further a coiled spring is provided between the band transmitting device and the torque releasing device.

### BACKGROUND OF THE INVENTION

1. Field of the Invention

This invention relates to a screw band locking device, particularly to one combined with a powered hand tool and possible to prevent a screw driver from damaging a locking groove in the head of a screw by remaining torque of the screw driver after the screw is driven properly into an object. The screw band locking device contains a torque releasing device provided with a driving member, permitting the locking torque of the screw driver to be released at the moment when a screw is properly driven into an object, so the locking groove in the head of a screw m ay not be damaged by remaining torque of the screw driver.

2. Description of the Prior Art

A conventional automatic screw band transmitting device, such as U.S. Pat. No. 5,284,074 (or Taiwan patent No. 201953), includes a snap disc fixed at an end of a shaft of the snap disc, and the snap disc is provided with plural snap teeth arranged in a balanced condition. When the snap disc is rotated, the snap teeth carry a screw band to move forward.

Another Taiwan patent No. 537124 disclosed a screw transmitting device, which has a screw moving unit including a gear installed in a front end of a gun nozzle, and the gear has projecting teeth to bite a screw band. When the gear rotates, the screw band is moved for one step by one step.

However, the two conventional screw band transmitting devices have a common disadvantage that there is a gap between the gear and the transmitting teeth of the screw band in the course of transmitting action. Furthermore, the gap may enlarge as repetition of the transmitting movement of the gear so that the screw band may move incorrectly. As its positioning way depends on the position hole of the snap disc, the screw locking locations of the screw band may become inaccurate owing to the inertia of the screw band not disappearing during the course of movement, so the bit cannot lock the screw band accurately.

The two conventional screw transmitting device may be used only with a powered hand tool that is provided with a torque releasing device, but this powered hand tool is very expensive for a user.

### SUMMARY OF THE INVENTION

The purpose of the invention is to offer a screw band locking device to be combined with a screw driver, so a user can drive a screw in an object for a needed depth, and the screw band locking device can release remaining torque of the screw driver at the moment when the screw is finished in driving, so the locking groove of the screw may not be damaged by remaining torque of the screw driver,

The invention has features described below.

1. It has a linking sleeve to be combined with a powered hand tool.

2. It has a torque releasing device provided with a combining rod for combining with a powered hand tool, and the combing rod has one end provided with a combining groove for receiving a screw driver, or a quick connecting head is added in the screw band locking device for connecting a screw driver.

3. The torque releasing device contained in it is provided with a driving member, which is driven by a band transmitting device for releasing torque of the screw driver.

4. The torque releasing device contained in it is provided with a main body to be combined with a powered hand tool, and the torque releasing device is installed in a inner rear portion of the main body, so that the torque releasing device may be driven by the band transmitting device so as to release timely remaining torque of the screw driver when a screw is driven in an object in a needed depth.

5. The band transmitting device in it is provided with stopping teeth in a side wall of a screw band groove, so the transmitting teeth of the screw band may be stopped by the stopping teeth after the empty screw band with the screw taken out is transmitted to a certain position by the band transmitting device, preventing the screw band from retreating.

### BRIEF DESCRIPTION OF DRAWINGS

This invention will be better understood by referring to the accompanying drawings, wherein:

FIG. 1 is a cross-sectional view of a screw band locking device in the present invention;

FIG. 2 is a partial cross-sectional view of the screw band locking device in the present invention;

FIG. 3 is a partial cross-sectional view of a rear stopping member combined after a driving member is combined with a band transmitting device in the present invention

FIG. 4 is a cross-sectional view of a torque releasing device combined with a powered hand tool for operation in the present invention;

FIG. 5 is another cross-sectional view of the torque releasing device combined with the powered hand tool for operation in the present invention;

FIG. 6 is a perspective view of the torque releasing device separated from a quick connecting head with a screw driver in the present invention;

FIG. 7 is a side and partial cross-sectional view of the quick connecting head in the present invention;

FIG. 8 is another side and partial cross-sectional view of the quick connecting head in the present invention;

FIG. 9 is an exploded perspective view of a band transmitting device in the present invention;

FIG. 10 is a perspective view of the band transmitting device in the present invention;

FIG. 11 is a cross-sectional view of the band transmitting device under operation in the present invention;

FIG. 12 is a side view of the band transmitting device in the present invention;

FIG. 13 is a cross-sectional view of the line A-A in FIG. 12;

FIG. 14 is a cross-sectional view of the line A-A in operation in FIG. 12;

FIG. 15 is a cross-sectional view of the band transmitting device in the present invention;

FIG. 16 is a perspective view of another band transmitting device in the present invention;

FIG. 17 is a cross-sectional view of the screw band locking device under a first course of operation in the present invention;

FIG. 18 is a cross-sectional view of the screw band locking device under a second course of operation in the present invention;

FIG. 19 is a cross-sectional view of the screw band locking device under a third course of operation in the present invention; and,

FIG. 20 is a cross-sectional view of another embodiment of a screw band locking device in the present invention;

### DETAILED DESCRIPTION OF THE PREFERRED EMBODIMENT

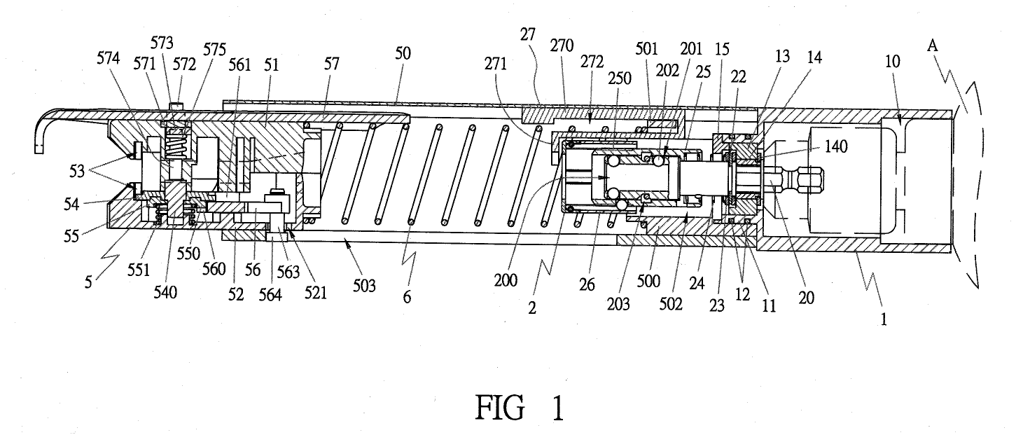

A preferred embodiment of a screw band locking device in the present invention, as shown in FIG. 1, includes a linking sleeve 1, a torque releasing device 2, a quick connecting head 3, and a band transmitting device 5 as main components.

The linking sleeve 1 is provided with a fitting groove 10 formed in its interior for combing with a powered hand tool (A), which may drive components of the screw band locking device. The linking sleeve 1 is further provided with a small diameter linking circumference 11 at one end, and plural seal rings 12 made of resilient plastic or rubber or silica gel fitted around the linking circumference 11, so the linking sleeve 1 may quickly be combined with the band transmitting device 5. Further a cylinder 13 is provided to be located inside the linking circumference 11, and a bearing 14 is put inside the cylinder 13, with a C-shaped locking ring 140 locking one end of the bearing 14. In addition, an eccentric cylinder 15 is added at the front side of the cylinder 13, and the bearing 14 made of plastic supports a combining rod 20 of the torque releasing device 2, advantageous for not wearing the combining rod 20. Moreover, the cylinder 13 made of plastic can absorb partial vibration, enabling handling of the screw band locking device more smoothly.

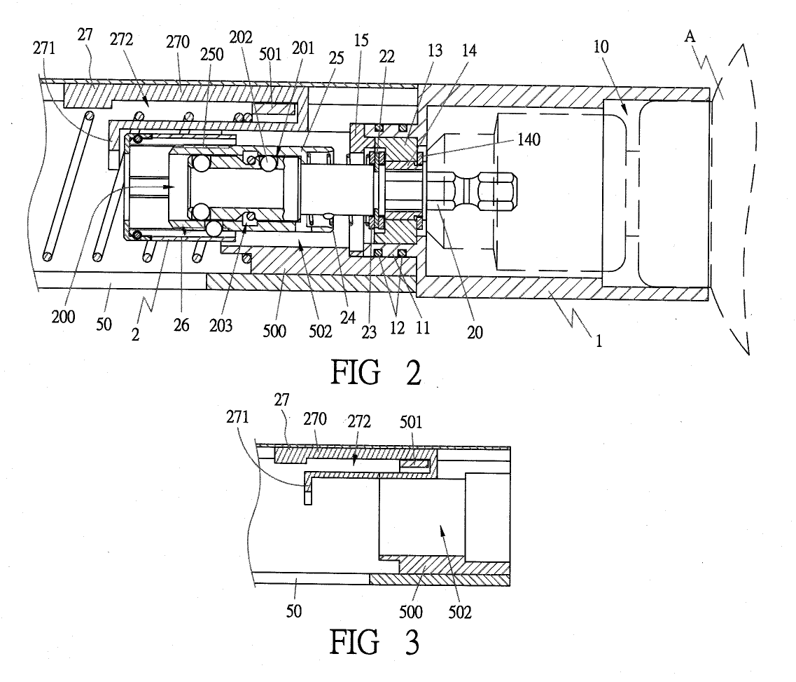

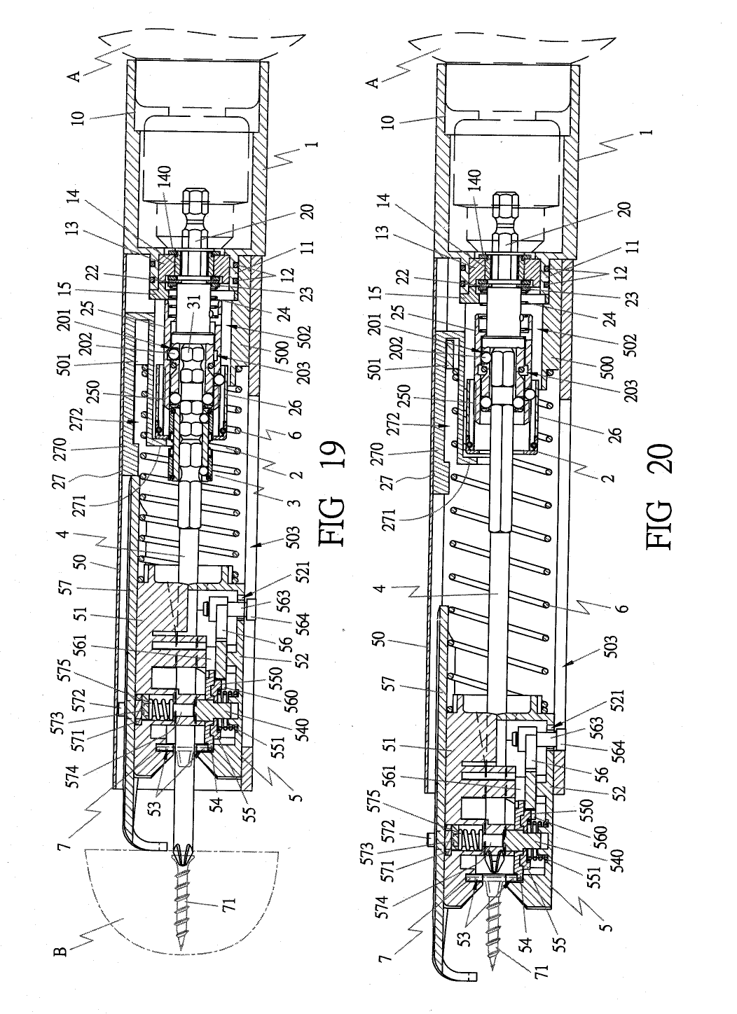

The torque releasing device 2, as shown in FIGS. 2, 3 and 4, is provided with the combining rod 20 in a rear portion, and the combining rod 20 has a front end combined with the powered hand tool (A) and a rear end formed with a combining groove 200 for connecting with the quick connecting head 3, which is to be combined with a screw driver 4. Or as shown in FIG. 20, the screw driver 4 is directly combined with the combining groove 200, without the quick connecting head 3.

As to the combining rod 20, it also has plural torque releasing bead grooves 210 formed in the combining groove 200 for receiving torque releasing beads 202 therein. Further, a torque releasing groove 203 is provided in an inner wall of the combining groove 200, so one of the torque releasing beads 202 may fit in the torque releasing grooves 203 after a screw is driven in an object for a certain depth, as shown in FIG. 19. Then the torque of the screw driver 4 may be released even a user still drives the powered hand tool (A). Or the power of the powered hand tool (A) is shut off, so the combining rod 20 may rotate idle in spite of the combining rod 20 still having partial torque remained.

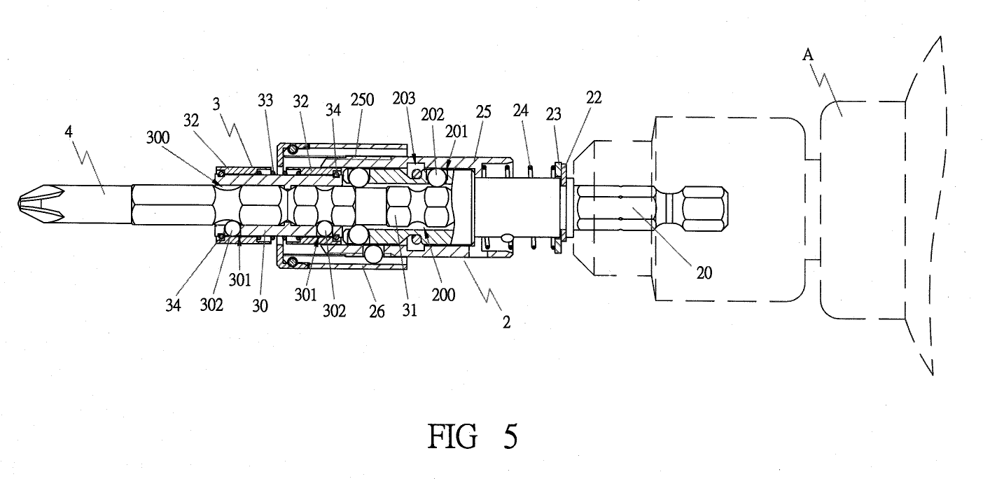

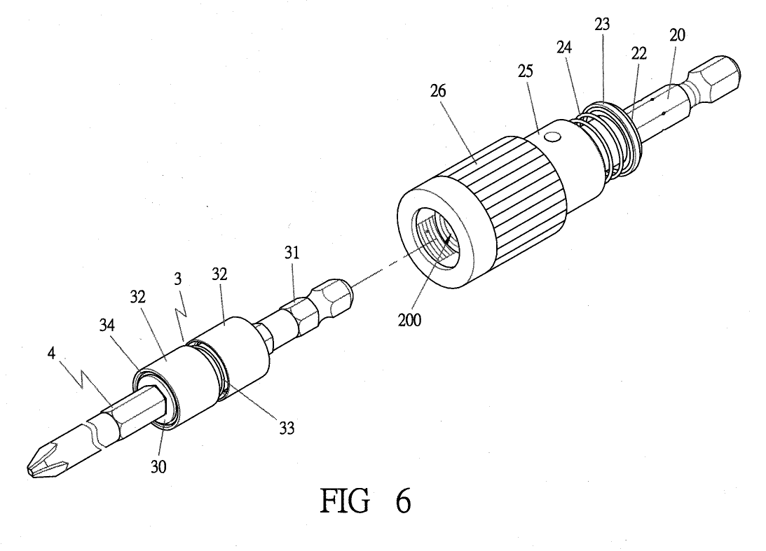

In addition, as shown in FIGS. 5 and 6, an E-shaped locking ring 22 is provided around the combining rod 20 of the torque releasing device 2, with a washer 23 and a spring 24 pushing the washer 23 put at one side of the E-shaped locking ring 22. Then an inner sleeve 25 with male threads 250 is provided around the outer surface of the combining groove 200 of the combining rod 20, and an outer sleeve 26 engaged with and fitted around the inner sleeve 25 is driven by a driving member 27.

The driving member 27 is installed at one side of the torque releasing device 2, as shown in FIGS. 2 and 3, provided with an extended portion 270 and a driving portion 271 inside the extending portion 270, and a fitting gap 272 defined between the extended portion 270 and the driving portion 271, for the wall of a stopping member 500 of a main body 50 of the band transmitting device 5 to fit therein for positioning the driving member 27 in place. Then the extended portion 270 can tightly rest on the inner wall of the main body 50. The driving portion 271 is located on the outer sleeve 26, so it can drive the outer sleeve 26 when the band transmitting device 5 drives the extended portion 270, releasing the torque of the screw driver 4, as shown in FIG. 19.

Next, the quick connecting head 3 is connected with the combining groove 200 of the combining rod 20 of the torque releasing device 2, provided with a tubular rod 30 with a through hole 300, as shown in FIGS. 5, 7 and 8. Then the screw driver 4 is combined with the quick connecting head 3 by fitted tightly in the front portion of the through hole 300, and a linking rod 31 is combined with the quick connecting head 3 by fitted tightly in the rear portion of the through hole 300. One purpose of the quick connecting head 3 is to swiftly change a screw driver, and the other purpose is to be combined separately with a screw driver and a linking rod, both of which have been combined at the same time, so an easily worn linking rod 31 only can be replaced with new one to save expense.

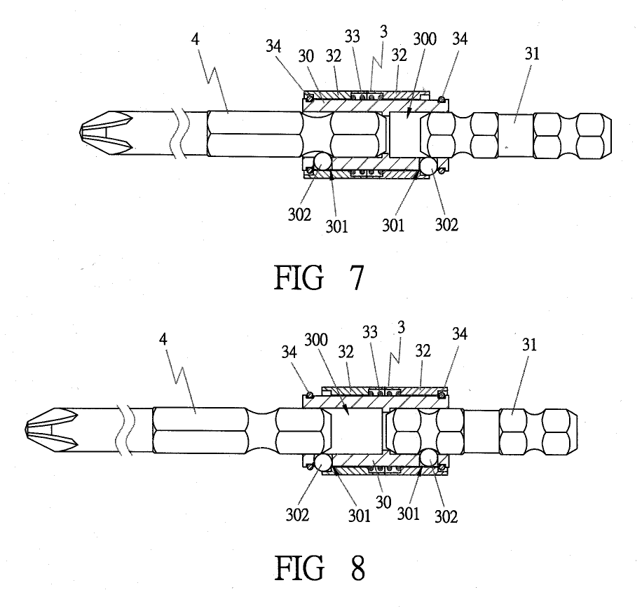

Next, an outer ring 32 is provided to fit around the tubular rod 30 of the quick connecting head 3, and the tubular rod 30 has plural positioning bead grooves 301 for receiving positioning beads 302 therein. Further, a spring 33 is provided in the outer ring 32, and an E-shaped locking ring 34 is deposited at the front end and the rear end respectively after the outer ring 32 is fitted around the tubular rod 30, fixing tightly the outer ring 32. Then the linking rod 31 (shown in FIG. 7) or the screw driver 4 (shown in FIG. 8) can be changed by rotating loose the outer ring 32.

The band transmitting device 5, as shown in FIGS. 1 and 15, is provided with a main body 50, which has a rear stopping member 500 installed in a inner rear portion, so the band transmitting device 5 can be fitted in the combining circumference 11 of the linking sleeve 1 by means of the stopping member 500 so that the main body 50 is combined fixedly with the linking sleeve 1. Further, the rear stopping member 500 is provided with a through hole 502 so that the torque releasing device 2 may be fitted in the through hole 502, or in the inner rear portion of the main body 50. In addition, a spring 6 is installed between the band transmitting device 5 and the rear stopping member 500, positioning the band transmitting device 5 in an inner front section of the main body 50.

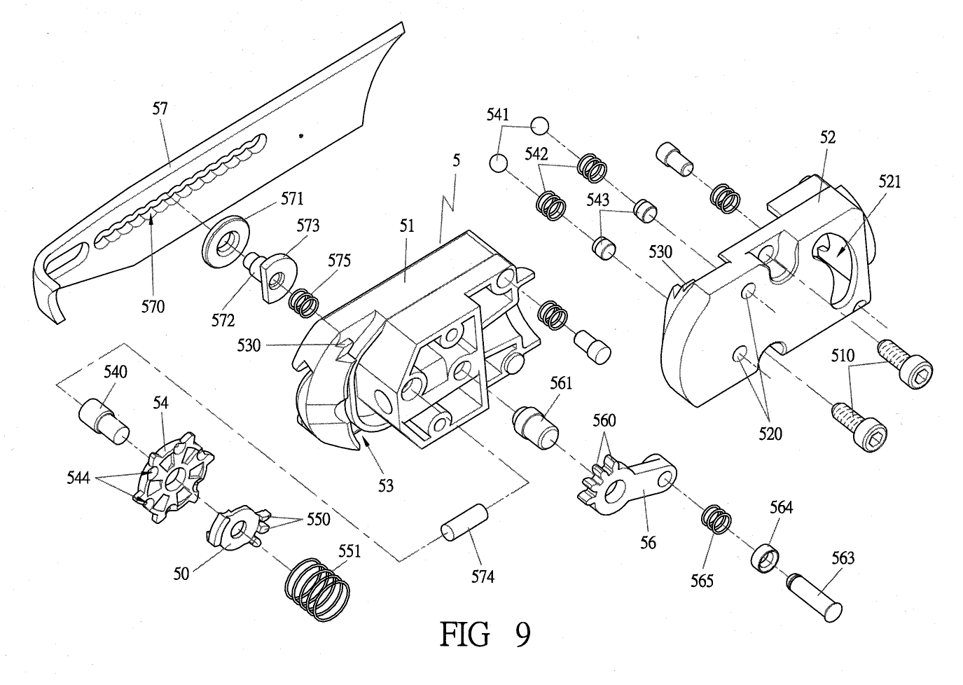

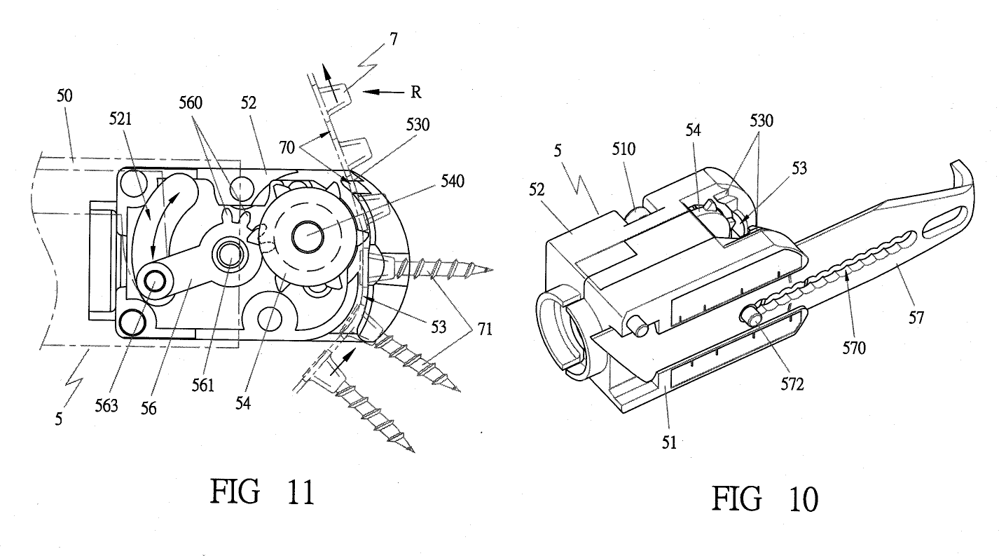

Next, the band transmitting device 5, as shown in FIGS. 9 and 10, is composed of a right and a left shell 51 and 52 in a symmetrical state and combined integral by means of fastening members 510, with a band groove 53 formed in a front portion of the combined shells 51 and 52. Further, stop teeth 530 are formed in both shells 51 and 52 at the top of the band groove 53, so transmitting teeth 70 of a screw band 7 located on the band transmitting device 5 may be stopped by the stop teeth 530, absolutely not allowing the screw band 7 to droop or retreat.

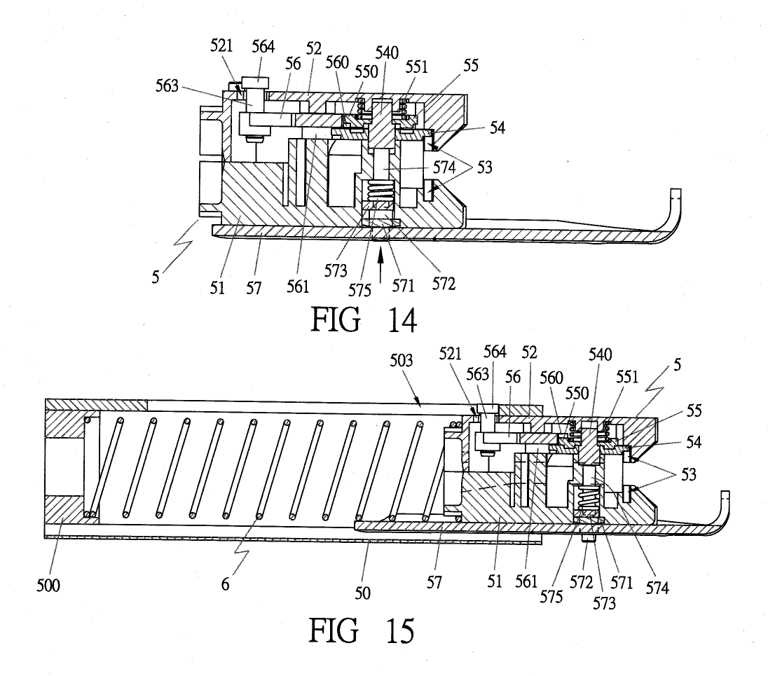

The band transmitting device 5 is provided with one-way ratchet gear 54, and a driving mass 55 is deposited at one side of the ratchet gear 54, having plural teeth 550. Then a coiled spring 551 is placed at one side of the driving mass 55, with a shaft 540 penetrating through the ratchet gear 54, the driving mass 55 and the coiled spring 551 in a line. As shown in FIG. 14, the driving mass 55 is connected with and drives the one-way ratchet gear 54 to rotate.

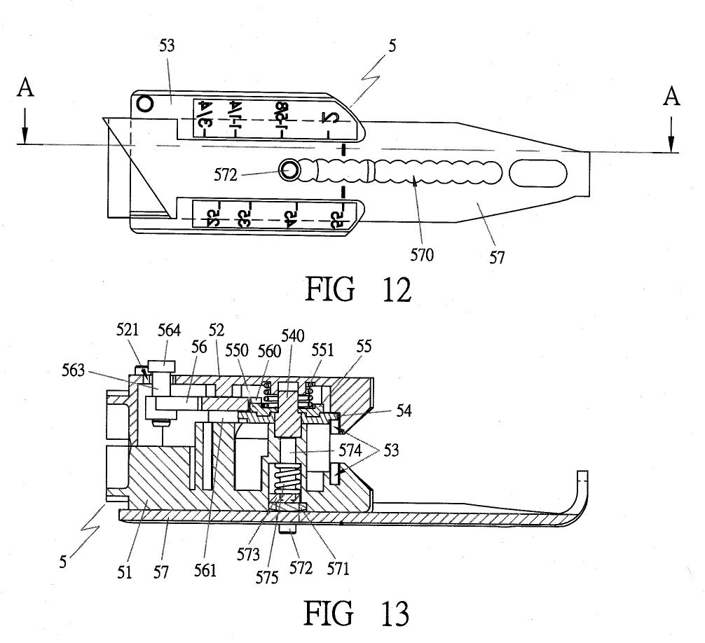

Next, the right shell 52 is provided with plural position beads 541 in its inner wall, as shown in FIG. 9, and a coiled spring 542 is placed at one side of each position beads 541, having one end fitted with a round block 543 embedded in a hole 520 in the right shell 52. Then the position beads 541 can duly catch the one-way ratchet gear 54 in place by fitting in the hole 544 thereof. Further, an actuating rod 56 is provided, having plural teeth 560 to engage with the teeth 550 of the driving mass 55, rotating the one-way ratchet gear 54 for a small angle preset via the driving mass 55, as shown in FIG. 12, transmitting the screw band 7 upward for a certain distance. Moreover, a shaft 561 is provided to pass through the front portion of the actuating rod 56, fixed inside the right and the left shell 51 and 52, as shown in FIGS. 11, 13 and 14.

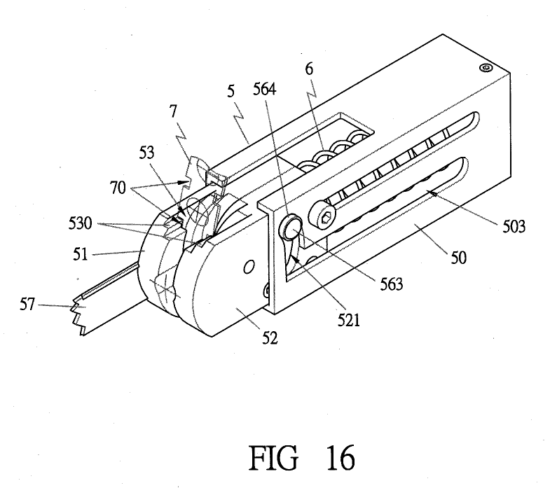

The actuating rod 56 has a hole in a rear portion for a movable shaft 563 to fit through, and a shaft sleeve 564 is fitted around the movable shaft 563, with a coiled spring 565 also fitting around the movable shaft 563. Then the movable shaft 563, the coiled spring 565, the shaft sleeve 564 together with the rear portion of the actuating rod 56 are fitted movably in an elongate slot 521 of the right shell 52, and further movable in the long L-shaped slide hole 503 of the main body 50 by means of the shaft sleeve 564 as well, as shown in FIG. 16. Therefore, the movable shaft 563 may move up and down in the elongate slot 521 of the right shell 52, and the actuating rod 56 moves the driving mass 55 and the one-way ratchet gear 54 altogether, forcing the screw band 7 to move up, as shown in FIG. 11. Then a screw 71 to be locked is moved to a set position, and the other screws on the locked screw band 7 are also moved to set positions, with the transmitting teeth 70 of the screw band 7 stopped by the stop teeth 530. Even though the coiled springs 542 of the position beads 541 are fatigued owing to long use and causing the positioning function not so good, the screw band 7 may absolutely not droop or retreat, enabling every screw 71 to be positioned at a very accurate location.

Moreover, the advantage of hampering the screw band from retreating makes every screw 71 transported and positioned in the set position immovable, permitting a screw driver can drive the screw 71 without fail. Besides, as shown in FIG. 11, if the screw band 7 is needed to be moved down, the screw band 7 is only pulled in the direction indicated by the arrow head (R) for a proper angle, with the transmitting teeth 79 disengaging from the stop teeth 530.

As shown in FIGS. 9 and 10, the band transmitting device 5 further has a locking-depth adjusting plate 57, which is provided with plural continual adjusting holes 570 formed lengthwise, and a cushion 571 located at inner side of the locking-depth adjusting plate 57 with a first shaft 572 passing through the cushion 571, a position block 573 located at a rear side of the first shaft 572 and at an outer side of the left shell 51, and a second shaft 574 penetrating the left shell 51 from the inner side, and a coiled spring 575 fitting around the second shaft 574 exposing out of the left shell 51 and further fitting in the first shaft 572, as shown in FIG. 14. If a user pushes the adjusting rod 57 inwards to urge the first shaft 572, the driving mass 55 may separate from the one-way ratchet gear 54 that can therefore rotate freely, as one way of adjusting a projecting length of the screw band 7. FIGS. 12 and 13 show that adjusting the combining location of the first shaft 572 and one of the adjusting holes 570 can adjust the length of the adjusting plate 57 for deciding the locking depth of a screw 71.

In operating the invention, before a user does not start the powered hand tool, as shown in FIG. 17, a screw 71 to be locked is located at the most front point of the screw band transmitting device 5, with the screw driver 4 separated from the screw 71.

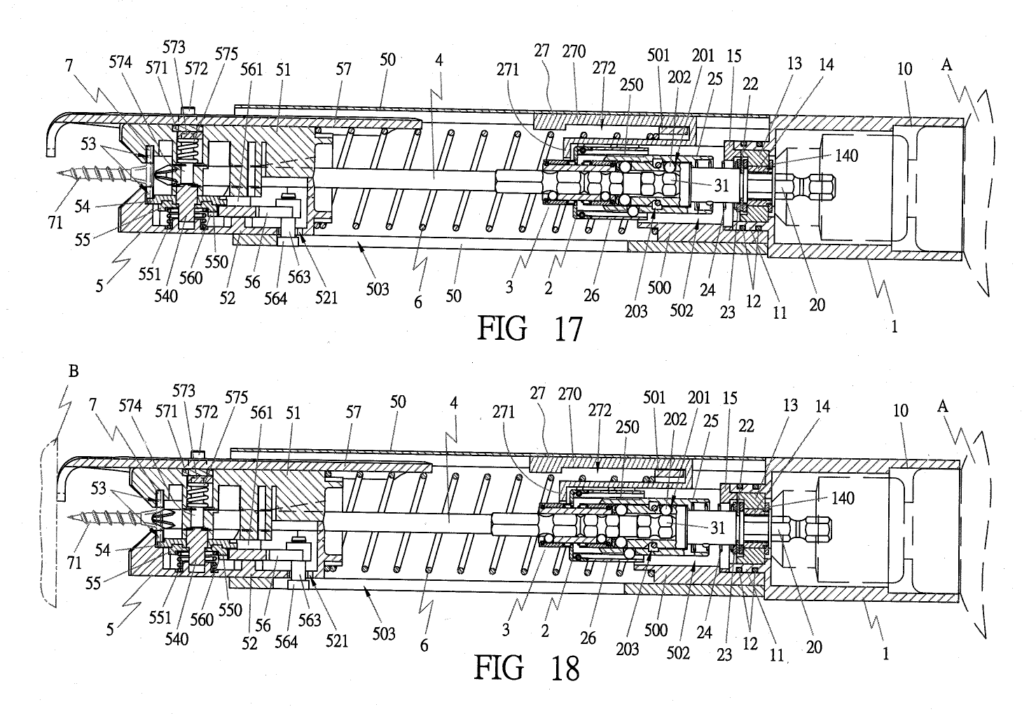

Further, as shown in FIG. 18, when the user is about to drive the screw 71 into an object (B), the user aims the screw 71 to the locking point of the object (B), letting the locking-depth adjusting plate 57 contact the object (B). At this moment, the band transmitting device 5 is retreated backward by force, permitting the screw driver 4 to push against the screw 71. Then the user starts the powered hand tool and forces the screw 71 driven into the object (B).

As shown in FIG. 19, if the user has driven the screw 71 into the object (B) to a needed depth, the locking-depth adjusting plate 57 of the band transmitting device 5 may have its rear end contact and drive the drive member 27 rearward, and then the drive member 27 shifts the outer ring 26 of the torque releasing device 2, forcing the torque releasing beads 202 move into the torque releasing grooves 203, and making the screw driver 4 rotate idly thereby.

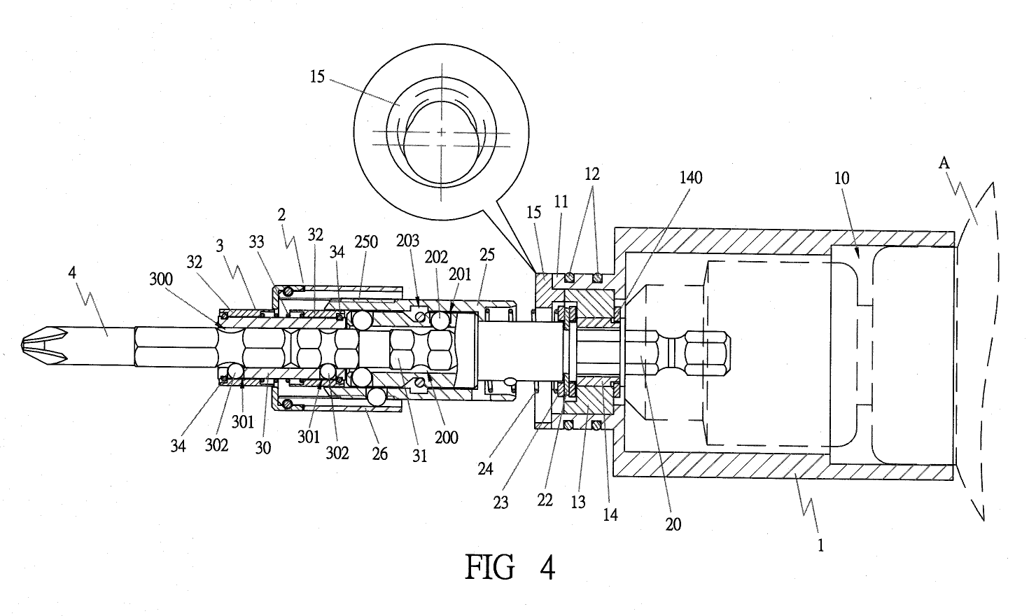

Lastly, the invention can also be independently used, and as shown in FIGS. 4 and 5, only the torque releasing device 2 can be combined with a powered hand tool (A) that can have the effect of torque releasing, stepping up the value of the powered hand tool.

While the preferred embodiment of the invention has been described, it will be recognized and understood that various modifications may be made therein the appended claims are intended to cover all such modifications that may fall within the spirit and scope of the invention.

1. The screw band locking device as claimed in claim 15, wherein
said torque releasing device is provided with a combining rod, said combining rod having one end to be combined with said powered hand tool, said combining rod further having a combining groove for a screw driver to fit therein; or a quick connecting head provided for combining with said screw driver; a driving member installed outside said torque releasing device, said driving member driven by said band transmitting device for driving said torque releasing device so that torque of said screw driver may be released.

2. The screw band locking device as claimed in claim 1, wherein said linking sleeve is provided with a fitting groove for combining a powered hand tool therewith.

3. The screw band locking device as claimed in claim 1, wherein said combining circumference of said linking sleeve is provided with plural seal rings.

4. The screw band locking device as claimed in claim 1, wherein said combining circumference of said linking sleeve is provided with a cylinder in its interior, and a bearing is installed in said cylinder, and a C-shaped locking ring fixes said bearing with said cylinder.

5. The screw band locking device as claimed in claim 1, wherein said combining rod of said torque releasing device is provided with plural torque releasing bead grooves for receiving torque releasing beads therein.

6. The screw band locking device as claimed in claim 1, wherein said combining rod of said torque releasing device is provided with a torque releasing groove in its inner wall.

7. The screw band locking device as claimed in claim 1, wherein said combining rod of said torque releasing device is fitted around with an E-shaped locking ring, a washer put beside said E-shaped locking ring and a coiled spring put beside said washer to push said washer.

8. The screw band locking device as claimed in claim 1, wherein an inner sleeve is provided to fit around said combining groove of said combining rod of said torque releasing device, having male threads for threadably engaging with an outer sleeve which fits around said inner sleeve.

9. The screw band locking device as claimed in claim 1, wherein said driving member is provided with an extended portion and a driving portion, with a fitting gap formed between said extended portion and said driving portion for contacting a wall of said rear stop member of said band transmitting device.

10. The screw band locking device as claimed in claim 1, wherein said rear stop member installed in said main body of said band transmitting device is provided with a through hole for receiving said torque releasing device therein, and a coiled spring is installed between said band transmitting device and said rear stop member.

11. The screw band locking device as claimed in claim 1, wherein said band transmitting device is provided with a one-way ratchet gear, a drive mass with plural teeth deposited at one side of said one-way ratchet gear, a coiled spring set at one end of said coiled spring, and a shaft penetrating said one-way ratchet gear and said drive mass together.

12. The screw band locking device as claimed in claim 1, wherein a right shell of said band transmitting device is provided with plural position beads in its inner wall, a coiled spring set at one side of each of said beads, and said coiled spring having its one end fitted with a round block, which is embedded in a hole in said right shell.

13. The screw band locking device as claimed in claim 1, wherein said band transmitting device is provided with a actuating rod, said actuating rod has plural teeth engaging with said teeth of said drive mass; a shaft penetrates a front portion of said actuating rod, and fixed firmly inside said right shell and a left shell; a movable shaft penetrates a rear portion of said actuating rod, a shaft sleeve with a coiled spring are fitted around said movable shaft, said shaft sleeve with coiled spring are fitted in a rear end of said actuating rod and further fitted in a elongate slot of said right shell, moving in an L-shaped slide hole of said main body of said band transmitting device by means of said shaft sleeve of said actuating rod.

14. The screw band locking device as claimed in claim 1, wherein
said quick connecting head is provided with a rod bored with a through hole for receiving a linking rod and a screw driver; said rod further provided with plural position bead grooves for receiving position beads therein; an outer ring fitted around said rod, a coiled spring deposited in said outer ring, an E-shaped locking ring fixing a front section and a rear section of said rod respectively after said outer ring is fitted around said rod to let said outer ring movable.

15. A screw band locking device comprising:
a linking sleeve able to be combined integral with a power hand tool, a combining circumference formed in one end portion of said linking sleeve, said combining circumference serving for combining with a rear stop member of a band transmitting device;
said band transmitting device provided with a main body, said main body provided with said rear stop member to be combined with said linking sleeve, a torque releasing device installed in a rear portion of said main body, a coiled spring deposited between said band transmitting device and said torque releasing device; and
said band transmitting device further provided with a right shell and a left shell combined together by said linking sleeve; a screw band groove formed in a front end after said right and said left shell are combined together, a stop tooth formed at top of said screw band groove to stop transmitting teeth of a screw band to prevent said screw band from drooping and retreating.

16. The screw band locking device as claimed in claim 15, wherein a drive mass is installed at one side of an one-way ratchet gear, said one-way ratchet gear is provided with plural teeth, a coiled spring is positioned at one side of said drive mass, and a shaft penetrates said one-way ratchet gear and said drive mass together.

17. The screw band locking device as claimed in claim 15, wherein said right shell is provided with plural position beads in its inner wall, a coiled spring is set at one side of each of said position beads and has one end fitted with a round block, which is embedded in a hole in said right shell.
